(19) United States
(12) Patent Application Publication
(10) Pub. No.: US 2014/0003507 A1
(43) Pub. Date: Jan. 2, 2014

(54) MULTIVIEW VIDEO DECODING DEVICE, METHOD AND MULTIVIEW VIDEO CODING DEVICE

(71) Applicant: KABUSHIKI KAISHA TOSHIBA, Minato-ku (JP)

(72) Inventors: Wataru ASANO, Kanagawa (JP); Tomoya Kodama, Kanagawa (JP)

(21) Appl. No.: 13/932,336

(22) Filed: Jul. 1, 2013

(30) Foreign Application Priority Data
Jul. 2, 2012 (JP) 2012-148603

(51) Int. Cl. H04N 7/32

(52) U.S. Cl. CPC H04N 19/00769
USPC 375/240.12

(57) ABSTRACT

According to an embodiment, a multiview video decoding device decodes a target image to be decoded using a first reference picture. The device includes a determining unit and a selecting unit. The determining unit determines whether or not an image of interest of a base viewpoint is an intra predictive image that has been decoded using intra prediction. The image of interest is included in a coded stream obtained by coding video viewed from a plurality of viewpoints and is earlier in a decoding order than the target image. When the determining unit determines that the image of interest is the intra predictive image, the selecting unit select, as the first reference picture, at least one image from the image of interest and an image that is viewed at a different time than the target image and that is decoded based on the image of interest.

### CROSS-REFERENCE TO RELATED APPLICATIONS

This application is based upon and claims the benefit of priority from Japanese Patent Application No. 2012-148603, filed on Jul. 2, 2012; the entire contents of which are incorporated herein by reference.

### FIELD

Embodiments described herein relate generally to a multiview video decoding device, method and a multiview video coding device.

### BACKGROUND

Typically, “H.264/AVC” is known as the technology used in video coding. Moreover, multiview video coding (MVC) is known as an extension for enabling reproduction of images viewed from various viewpoints.

However, in multiview video coding, it is difficult to achieve reduction in delay as well as a high coding efficiency at the same time.

### BRIEF DESCRIPTION OF THE DRAWINGS

FIG. 1 is a diagram illustrating a first example of prediction structure of multiview video coding;

FIG. 2 is a diagram illustrating a second example of prediction structure of multiview video coding;

FIG. 3 is a diagram illustrating a third example of prediction structure of multiview video coding;

FIG. 4 is a block diagram illustrating an exemplary configuration of a video decoding device according to an embodiment;

FIG. 5 is a block diagram illustrating an exemplary configuration of a reference picture setting unit in the video decoding device according to the embodiment;

FIG. 6 is a flowchart for explaining a decoding operation performed in the video decoding device according to the embodiment;

FIG. 7 is a diagram illustrating a fourth example of prediction structure according to the embodiment;

FIG. 8 is a block diagram illustrating an exemplary configuration of a modification example of the video decoding device according to the embodiment;

FIG. 9 is a flowchart for explaining an output image selecting operation performed in the modification example of the video decoding device according to the embodiment;

FIG. 10 is a block diagram illustrating a configuration of a modification example of the reference picture setting unit according to the embodiment;

FIG. 11 is a flowchart for explaining the operations performed in a video decoding device that includes a viewpoint number setting unit according to the embodiment;

FIG. 12 is a diagram illustrating a fifth example of prediction structure according to the embodiment;

FIG. 13 is a flowchart for explaining the operations performed in a modification example of the video decoding device that includes the viewpoint number setting unit according to the embodiment;

FIG. 14 is a block diagram illustrating an exemplary configuration of a video coding device according to the embodiment; and

FIG. 15 is a flowchart for explaining the operations performed in the video coding device according to the embodiment with a focus on the operations performed by the reference picture setting unit.

### DETAILED DESCRIPTION

According to an embodiment, a multiview video decoding device decodes a target image to be decoded using a first reference picture. The device includes a determining unit and a selecting unit. The determining unit determines whether or not an image of interest of a base viewpoint is an intra predictive image that has been decoded using intra prediction. The image of interest is included in a coded stream obtained by coding video viewed from a plurality of viewpoints and is earlier in a decoding order than the target image. When the determining unit determines that the image of interest is the intra predictive image, the selecting unit select, as the first reference picture, at least one image from the image of interest and an image that is viewed at a different time than the target image and that is decoded based on the image of interest.

Background

First of all, explained below with reference to the accompanying drawings is the background that led to devising a video decoding method and a video coding method according to an embodiment.

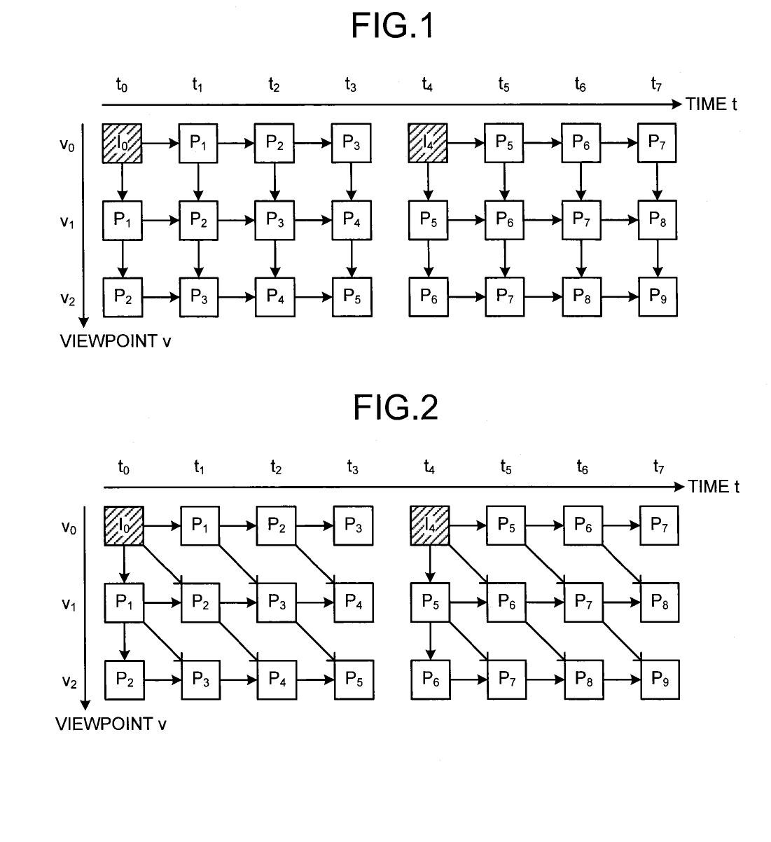

FIG. 1 is a diagram illustrating a first example of prediction structure of multiview video coding. In FIG. 1 are illustrated images that are viewed from three viewpoints v (v₀ to v₂) at times t₀ to t₇. Moreover, as an example, it is assumed that the viewpoint v₀ serves as the base view (described later). Each image I represents an intra coding image (intra-picture (I-picture)) that is coded by using intra prediction. Each image P represents an inter-frame forward predictive image (a predictive-picture (P-picture)) that is coded by using inter-frame forward prediction coding. Herein, the number attached to each image I and to each image P represents the processing order of coding or decoding. The images having the same number attached thereto can be processed in a concurrent manner.

Each image I is an instantaneous decoding refresh (IDR) picture and can be the first image while performing a random access. Herein, a solid arrow drawn between two images represents the reference relationship during coding or decoding. The image from which a particular solid arrow starts serves as the reference picture of the image at which that particular solid arrow ends. In the following explanation, unless otherwise specified; the times t, the viewpoints v, the images I, the images P, the numbers attached to the images, and the solid arrows substantively have the same meaning as the meaning described above.

In the first example of prediction structure illustrated in FIG. 1, for a certain image of interest, an image that is viewed at the same time as the certain image but from a different viewpoint is used as a reference picture. For example, for an image P₁ viewed from the viewpoint v₁ at the time t₀; an image I₀ viewed from the viewpoint v₀ at the time t₀ is used as the reference picture. Similarly, for an image P₂ viewed from the viewpoint v₂ at the time t₀; the image P₁ viewed from the viewpoint v₁ at the time t₀ is used as the reference picture. Thus, in the first example of prediction structure, the images viewed at the same time but from different viewpoints cannot be subjected to parallel processing. For that reason, depending on the number of viewpoints, a delay occurs in the processing.

FIG. 2 is a diagram illustrating a second example of prediction structure of multiview video coding. In FIG. 2, except for the reference relationship present between each image I and the images viewed at the corresponding same time but from different viewpoints, the reference relationships between viewpoints at the same time are eliminated. However, in this case, each image I is referred to by the other images at the corresponding same time. As a result, the delay gets propagated.

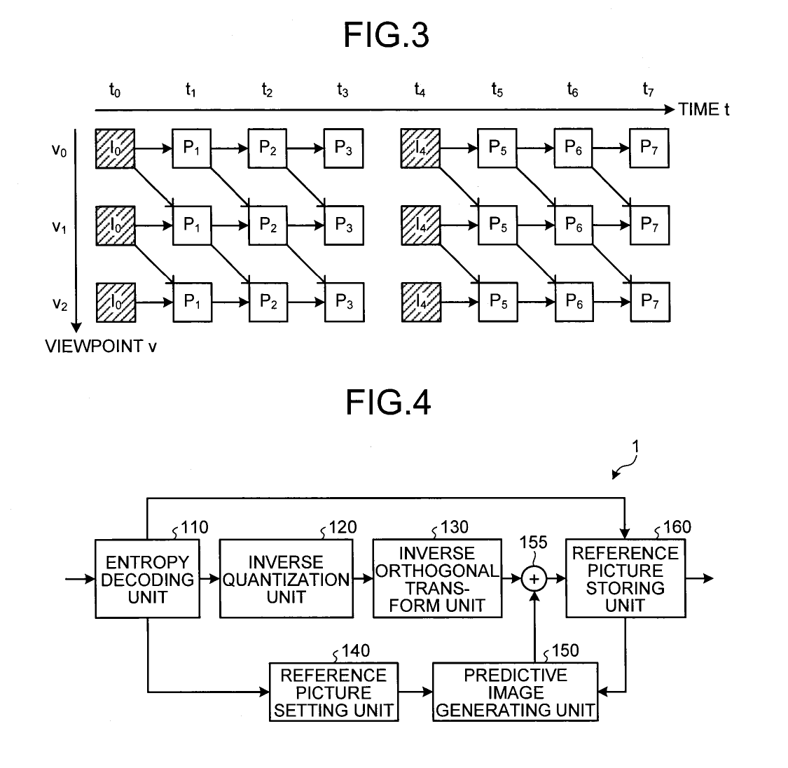

FIG. 3 is a diagram illustrating a third example of prediction structure of multiview video coding. In FIG. 3, all reference relationships between viewpoints at the same time are eliminated. Hence, unlike the first example and the second example, there occurs no delay that is dependent on the reference relationships between images. However, in this case, the first image at each of the viewpoints v₀ to v₂ is an intra predictive image (an image I). As a result, there occurs a decline in the coding efficiency as compared to the first example and the second example.

Video Decoding Device According to Embodiment

Given below is the explanation about a video decoding device 1 according to the embodiment. FIG. 4 is a block diagram illustrating an exemplary configuration of the video decoding device 1. As illustrated in FIG. 4, the video decoding device 1 includes an entropy decoding unit 110, an inverse quantization unit 120, an inverse orthogonal transform unit 130, a reference picture setting unit 140, a predictive image generating unit 150, an adding unit 155, and a reference picture storing unit 160.

The entropy decoding unit 110 performs entropy decoding of a coded stream, which is obtained by coding a video viewed from a plurality of viewpoints, and obtains each piece of coding element information (syntax element). The inverse quantization unit 120 performs inverse quantization of the quantized transform coefficients, which is a type of coding element information, and obtains a transform coefficients. The inverse orthogonal transform unit 130 performs inverse orthogonal transform with respect to the transform coefficients and obtains a predictive error signal. The reference picture setting unit 140 selects a reference picture according to the coding element information. The predictive image generating unit 150 obtains the selected reference picture from the reference picture storing unit 160 and generates a predictive image. The adding unit 155 adds up the predictive image and the predictive error signal and obtains a decoded image. The reference picture storing unit 160 stores therein a decoded image and outputs it at a suitable timing according to the coding element information.

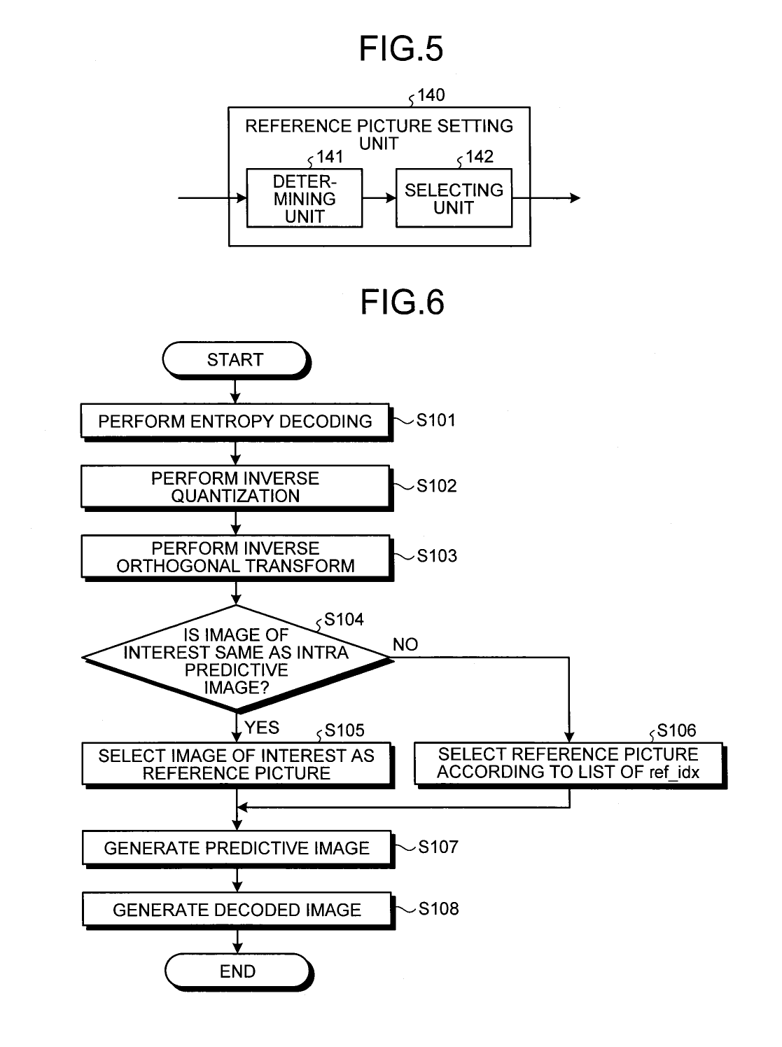

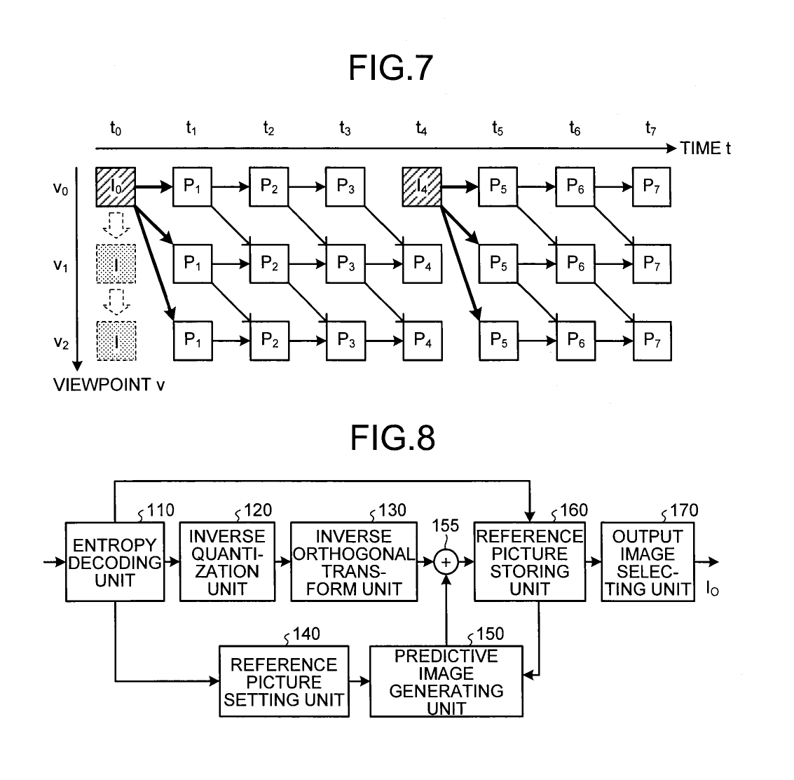

FIG. 5 is a block diagram illustrating the details of the reference picture setting unit 140. Herein, the reference picture setting unit 140 includes a determining unit 141 and a selecting unit 142. The determining unit 141 determines whether or not the target image to be decoded satisfies a predetermined condition. More particularly, the determining unit 141 determines whether or not the image of interest (see FIG. 7) of a base viewpoint, which is earlier in the decoding order than the target image, is an intra predictive image that has been decoded using intra prediction. Herein, the base viewpoint points to the base view, which is set, for example, to enable the viewpoints to maintain the compatibility with a single coded stream. The selecting unit 142 selects a reference picture on the basis of the determination result. If it is determined that the image of interest is an intra predictive image; then, as the reference picture of the target image, the selecting unit 142 selects at least one image from the image of interest and an image that is viewed at a different time than the target image and that is decoded based on the image of interest.

Given below is the explanation regarding a decoding operation performed in the video decoding device 1. FIG. 6 is a flowchart for explaining the decoding operation performed in the video decoding device 1. FIG. 7 is a diagram illustrating a fourth example of prediction structure of multiview video coding and multiview video decoding according to the embodiment.

As illustrated in FIG. 6, the entropy decoding unit 110 decodes the information that is included in a coded stream received as input and that has been subjected to entropy coding; and obtains a coded image type (slice_type), a reference picture index (ref_idx), a motion vector, and a variety of coding element information (syntax element) such as the quantized transform coefficients (Step S101). As specific examples, the entropy coding includes the Huffman coding and the arithmetic coding.

Then, the inverse quantization unit 120 performs inverse quantization on the basis of the quantized transform coefficients obtained at Step S101 and a quantization parameter (QP), and obtains a transform coefficients (Step S102).

Subsequently, the inverse orthogonal transform unit 130 performs inverse orthogonal transform with respect to the transform coefficients and obtains a predictive residual signal (Step S103). As specific examples, the inverse orthogonal transform includes the inverse discreet cosine transform (IDCT) and the inverse Hadamard transform.

Then, the determining unit 141 determines whether or not the image of interest of the base viewpoint, which is earlier in the decoding order (for example, immediately before in the decoding order) than the target image, is an intra predictive image that has been decoded using intra prediction (Step S104). If the determining unit 141 determines that the image of interest is an intra predictive image (Yes at Step S104); then the system control proceeds to Step S105. On the other hand, if the determining unit 141 determines that the image of interest is not an intra predictive image (No at Step S104); then the system control proceeds to Step S106. Herein, the determining unit 141 can also refer to a reference picture list under the condition prior to performing reference picture setting and make use of the time of the first reference picture (i.e., can make use of the image in RefPicList0[0] (ref_idx=0 in List0) specified in H.264).

At Step S105, the selecting unit 142 selects the image of interest as the reference picture (Step S105). For example, as illustrated by thick arrows in FIG. 7, with respect to the images P₁ (i.e., the target images) viewed from the viewpoints v₀ to v₂ at the time t₁; the selecting unit 142 selects, as the reference picture, the image of interest (i.e. the image of the base viewpoint v₀ at the time t₀ which is earlier in the decoding order (for example, immediately before in the decoding order). As a specific example, the selecting unit 142 sets the image of interest (i.e., the image Id as the reference picture in RefPicList0[0] and empties everything else.

At Step S106, the selecting unit 142 selects a reference picture according to the reference picture list (list of ref_idx) (Step S106). As a specific example, the selecting unit 142 does not make any changes in RefPicList0 and RefPicList1.

Then, the predictive image generating unit 150 obtains the selected reference picture from the reference picture storing unit 160 and generates a predictive image according to motion vector information (Step S107).

Subsequently, the adding unit 155 adds up the predictive image and the predictive residual signal and generates a decoded image (Step S108).

Meanwhile, the operations at Step S102 and Step S103 and the operations at Step S104 to Step S107 can either be reversed in order or be performed in parallel.

Thus, the video decoding device 1 can decode a coded multiview video stream that is coded using the fourth example of prediction structure illustrated in FIG. 7. In the fourth example of prediction structure illustrated in FIG. 7, since no reference relationships are present between viewpoint images viewed at the same time, the images that are viewed at the same time can be decoded in parallel. As a result, video decoding having a low delay can be achieved.

Moreover, the video decoding device 1 regards, as identical to the image I₀ (that is, regards as copies of the image I₀) of the base viewpoint v₀ at the time t₀, the images viewed from the viewpoints other the base viewpoint (i.e., viewed from the viewpoints v₁ and v₂) at the time t₀, at which the image of the base viewpoint v₀ is an intra predictive image. Furthermore, in the video decoding device 1, at least at least one image from among the intra predictive image viewed from the base viewpoint and the images decoded based on the intra predictive image viewed from the base viewpoint is selected as the reference picture of the target image. As a result, it becomes possible to perform random accessing or error recovery using the intra predictive image. Moreover, the configuration of the video decoding device 1 can be such that, as images other than the image viewed from the base viewpoint at the decoding start time, instead of using copies of the image viewed from the base viewpoint, different viewpoint images are synthesized using warping and the synthetic image is output.

Alternatively, the video decoding device 1 can be configured to switch, for each coded stream, between the fourth example of prediction structured illustrated in FIG. 7 and a prediction structure such as the MVC that is an extension of H.264/AVC and that refers to the images viewed from other viewpoints at the same time. For example, the video decoding device 1 can be configured to hold a prediction structure switching flag in the sequence header. When that flag indicates the fourth example of prediction structure illustrated in FIG. 7, the video decoding device 1 can perform the reference picture setting operation explained with reference to FIG. 6. Moreover, in the case when a video coding device performs the determination operation at Step S104 (FIG. 6) and includes the determination result as a flag (anchor_pic_flag) in the coded stream, then the video decoding device 1 can read that flag instead of performing the operation at Step S104.

Modification Example of Video Decoding Device

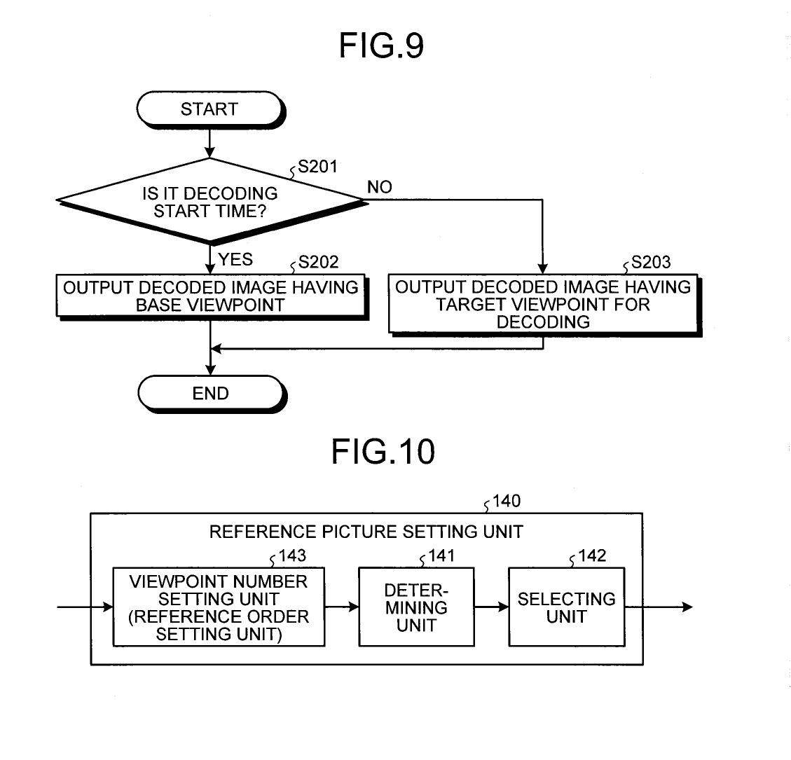

Given below is the explanation about a modification example of the video decoding device 1 according to the embodiment. FIG. 8 is a block diagram illustrating an exemplary configuration of the modification example of the video decoding device 1. As illustrated in FIG. 8, the modification example of the video decoding device 1 further includes an output image selecting unit 170 in addition to the configuration of the video decoding device 1 illustrated in FIG. 4. The output image selecting unit 170 selects an output image from decoded images. Moreover, the output image selecting unit 170 is configured to be able to perform at least either the selection described later with reference to FIG. 9 or the selection described later with reference to FIG. 13.

FIG. 9 is a flowchart for explaining an output image selecting operation performed in the modification example of the video decoding device 1. As illustrated in FIG. 9, the output image selecting unit 170 determines whether or not the time of an image(s) to be output is same as the decoding start time (Step S201). If the time of an image(s) to be output is determined to be same as the decoding start time (Yes at Step S201), then the system control proceeds to Step S202. On the other hand, if the time of an image(s) to be output is not determined to be same as the decoding start time (No at Step S201), then the system control proceeds to Step S203.

At Step S202, the output image selecting unit 170 selects and outputs the decoded image of the base viewpoint (Step S202).

At Step S203, the output image selecting unit 170 selects and outputs the decoded image(s) having the decoding target viewpoint(s) (Step S203).

The output image selecting unit 170 selects an output image as illustrated in FIG. 9 because the condition of the decoding start time is one of the following two conditions. For example, the first condition at the decoding start time is that only the image having the base viewpoint is included in the coded stream (that is, with reference to FIG. 7, an image to be output is only the image I₀ at the time t₀). The second condition at the decoding start time is that, although images other than the image of the base viewpoint are also included in the coded stream, it is the decoded images prior to the decoding start time that are referred to, and as a result, the reference picture is absent, and successful decoding cannot be performed (see the timing t₄ in FIG. 7).

In FIG. 7, in the modification example of the video decoding device 1, under the condition at the time t₀ (in the case when no copy images are present at the viewpoints v₁ and v₂), the first image during random accessing is not a multiview image but a 2D image; however, since none of the images having different viewpoints at the same time is considered as the reference picture, video decoding having a low delay can be achieved.

Given below is a modification example of the reference picture setting unit 140. FIG. 10 is a block diagram illustrating a configuration of the modification example of the reference picture setting unit 140. As illustrated in FIG. 10, the modification example of the reference picture setting unit 140 further includes a viewpoint number setting unit (a reference order setting unit) 143 in addition to the configuration of the reference picture setting unit 140 illustrated in FIG. 5. The viewpoint number setting unit 143 sets a viewpoint number to each viewpoint. Herein, the viewpoint numbers indicate the reference order among the viewpoints. Thus, the video decoding device 1 determines the reference picture among the viewpoints in order of viewpoint numbers.

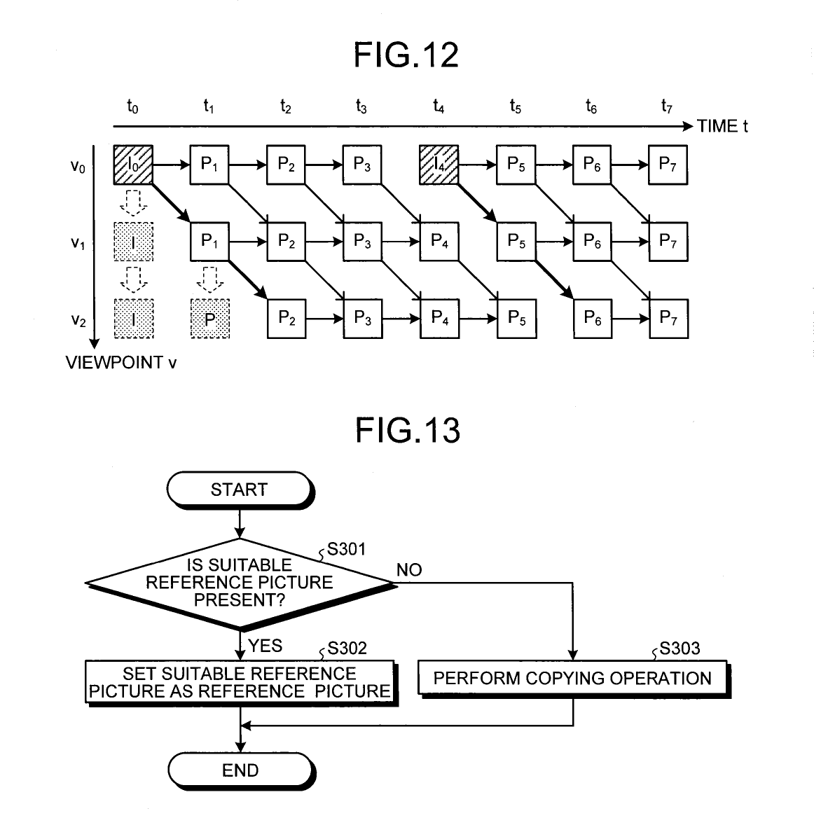

When the viewpoint number setting unit 143 sets the viewpoint numbers (i.e., sets the reference order); the selecting unit 142 can be configured to select, as the reference picture of the target image, a suitable reference picture that is previous in the reference order and that is viewed immediately before the target image from a different viewpoint that the target image. If no suitable reference picture is present, then the selecting unit 142 can be configured not to select a reference picture. Moreover, if no suitable reference picture is present, then the selecting unit 142 can be configured to regard, as identical to the target image, an image that is previous in the reference order and that is viewed at the immediately before the target image but from a different viewpoint. For example, consider a case in which no suitable reference picture is present at the viewpoint v₂ at the time t₁ illustrated in FIG. 12 (described later). In that case, the selecting unit 142 regards, as identical to the target image, the image which is previous in the reference order (i.e., the viewpoint v₁) and which is viewed at the same time as the target image (at time t₁) from a different viewpoint (i.e., the viewpoint v₁) (that is, the selecting unit 142 performs a copying operation). Meanwhile, when the viewpoint number setting unit 143 sets the viewpoint numbers, the determining unit 141 can be configured to determine the presence or absence of a suitable reference picture.

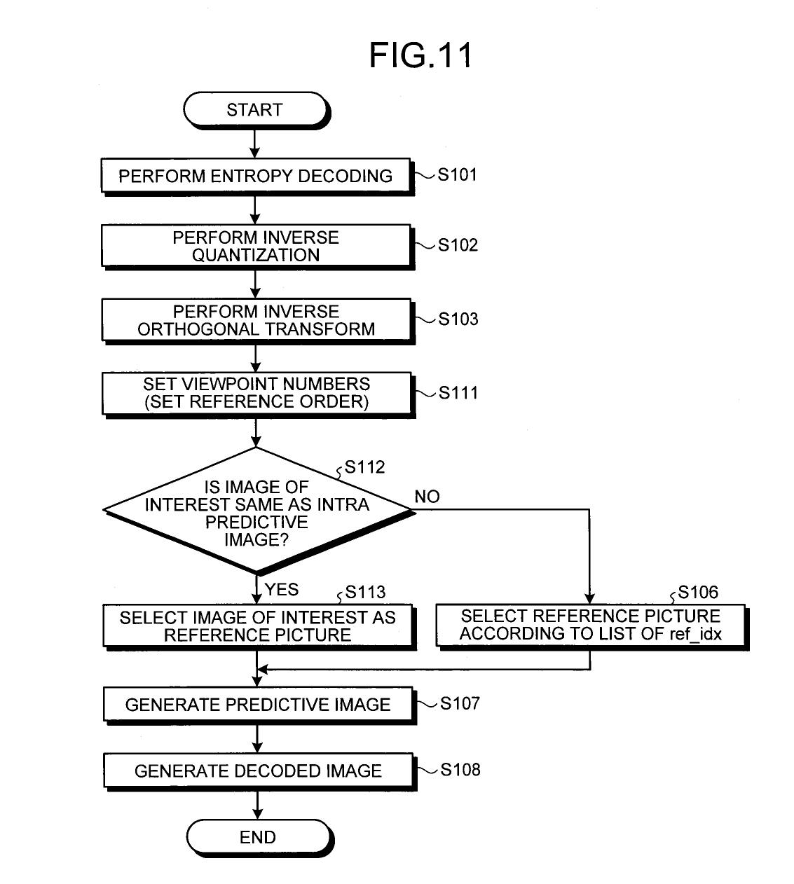

FIG. 11 is a flowchart for explaining the operations performed in the video decoding device 1 that includes the viewpoint number setting unit 143. FIG. 12 is a diagram illustrating a fifth example of prediction structure of multiview video coding (a video coding method) and multiview video decoding (a video decoding method) according to the embodiment. Meanwhile, in the flowchart illustrated in FIG. 11, the operations that are substantively identical to the operations illustrated in FIG. 6 are referred to by the same step numbers.

The viewpoint number setting unit 143 sets a viewpoint number to each viewpoint (i.e., sets a reference order) (Step S111). Herein, for example, the viewpoint number setting unit 143 refers to the values of viewpoint numbers that are written in the coded stream and determines the number to be set to each viewpoint.

Then, for example, the determining unit 141 determines whether or not the image of interest of the base viewpoint (see FIG. 7), which is earlier in the reference order than the target image, is an intra predictive image that has been decoded using intra prediction (Step S112). If the determining unit 141 determines that the image of interest is an intra predictive image (Yes at Step S112); then the system control proceeds to Step S113. On the other hand, if the determining unit 141 determines that the image of interest is not an intra predictive image (No at Step S112); then the system control proceeds to Step S106.

At Step S113, as the reference picture of the target image, the selecting unit 142 selects a suitable reference picture that is previous by one or more images in the reference order and that is viewed at a time immediately before the target image from a different viewpoint. However, if no suitable reference picture is present, then the selecting unit 142 does not select a reference picture (see thick arrows illustrated in FIG. 12) (Step S113). Moreover, if no suitable reference picture is present, then the selecting unit 142 can be configured to regards, as identical to the target image, the image which is previous in the reference order and which is viewed at a time immediately before the target image but from a different viewpoint.

Meanwhile, the operations at Step S102 and Step S103 and the operations at Step S111 to Step S107 can either be reversed in order or be performed in parallel. Thus, in the video decoding device 1 that includes the viewpoint number setting unit 143 can decode the coded multiview video stream that is coded in the fifth example of prediction structure illustrated in FIG. 12. In the fifth example of prediction structure illustrated in FIG. 12, since no reference relationships are present between viewpoint images viewed at the same time, the images that are viewed at the same time can be decoded in parallel. As a result, video decoding having a low delay can be achieved. Moreover, in the case when a video coding device performs the determination operation at Step S112 (FIG. 11) and includes the determination result as a flag (anchor_pic_flag) in the coded stream, then the video decoding device 1 including the viewpoint number setting unit 143 can read that flag instead of performing the operation at Step S112.

Given below is the explanation of the operations performed in a modification example of the video decoding device 1 (see FIG. 8) that includes the viewpoint number setting unit 143 (see FIG. 10). FIG. 13 is a flowchart for explaining the operations performed in the modification example of the video decoding device 1 that includes the viewpoint number setting unit 143.

As illustrated in FIG. 13, the determining unit 141 determines the presence or absence of a suitable reference picture (Step S301). If the determining unit 141 determines that a suitable reference picture is present (Yes at Step S301); then the system control proceeds to Step S302. On the other hand, if the determining unit 141 determines that no suitable reference picture is present (No at Step S301); then the system control proceeds to Step S303.

At Step S302, as the reference picture of the target image, the selecting unit 142 sets the suitable reference picture that is previous in the reference order and that is viewed at a time immediately before the target image from a different viewpoint (see FIG. 12) (Step S302).

At Step S303, the selecting unit 142 regards the image which is previous by one image in the reference order and which is viewed at the same time but from a different viewpoint as identical to the target image (i.e., the selecting unit 142 performs a copying operation) (Step S303). Meanwhile, the selecting unit 142 can also regards the image which is previous by two or more images in the reference order and which is viewed at the same time but from a different viewpoint as identical to the target image. In this way, in the modification example of the video decoding device 1 that includes the viewpoint number setting unit 143, it becomes possible to decode the coded multiview video stream that is coded using the prediction structure illustrated in FIG. 12.

In FIG. 12, the first images (at the time t₀) of the coded streams do not include images other than the image of the base viewpoint. Moreover, in the fifth example of prediction structure illustrated in FIG. 12, depending on the number of viewpoints, it takes time to include the images of all viewpoints in the coded stream. Hence, the first image during random accessing is not a multiview image but a 2D image. Even after that, stereoscopic viewing is possible from particular positions. However, unless a predetermined amount of time elapses, the images are seen as 2D images from the other positions. On the other hand, since the images of other viewpoints at the same time are not considered as reference pictures, video decoding having a low delay can be achieved.

In this way, in the video decoding method according to the embodiment, if it is determined that the image of interest is an intra predictive image; at least one image from among the image of interest and an image that is viewed at a different time than the target image and that is decoded based on the image of interest is selected as the reference picture of the target image. As a result, it becomes possible to achieve reduction in delay as well as a high coding efficiency at the same time.

Video Coding Device According to Embodiment

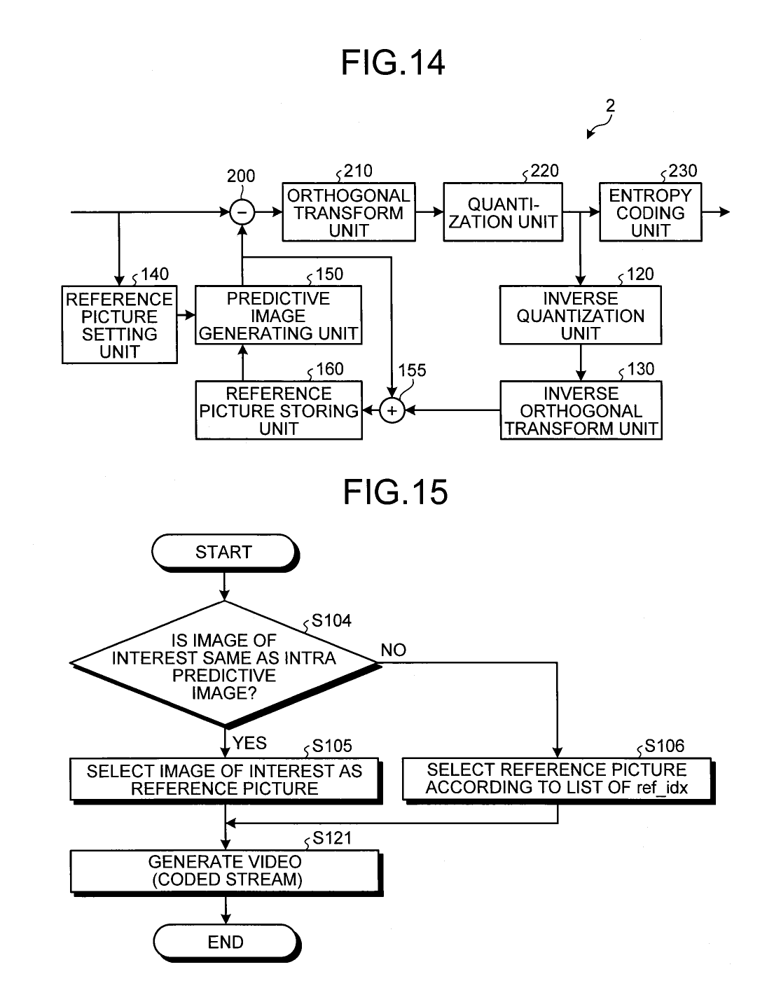

Given below is the explanation about a video coding device according to the embodiment. FIG. 14 is a block diagram illustrating an exemplary configuration of a video coding device 2 according to the embodiment. As illustrated in FIG. 14, the video coding device 2 includes a subtracting unit 200, an orthogonal transform unit 210, a quantization unit 220, an entropy coding unit 230, the inverse quantization unit 120, the inverse orthogonal transform unit 130, the reference picture setting unit 140, the predictive image generating unit 150, the adding unit 155, and the reference picture storing unit 160. In the video coding device 2, the constituent elements that are substantively identical to the constituent elements of the video decoding device 1 illustrated in FIG. 4 are referred to by the same reference numerals.

The orthogonal transform unit 210 performs orthogonal transform with respect to the difference value between an input image and a predictive image. The quantization unit 220 performs quantization of a transform coefficients. The entropy coding unit 230 performs entropy coding with respect to each piece of coding element information such as the quantized transform coefficients. The inverse quantization unit 120 performs inverse quantization of the quantized transform coefficients and obtains a transform coefficients. The inverse orthogonal transform unit 130 performs inverse orthogonal transform with respect to the transform coefficients and obtains a predictive error signal. The reference picture setting unit 140 selects a reference picture according to the coding order of the input image. The predictive image generating unit 150 obtains the selected reference picture from the reference picture storing unit 160 and generates a predictive image. The reference picture storing unit 160 stores therein a local decoded image that is obtained by adding the predictive image and the predictive error signal.

Given below is the explanation about the operations performed in the video coding device 2 with a focus on the operations performed by the reference picture setting unit 140. FIG. 15 is a flowchart for explaining the operations performed in the video coding device 2 with a focus on the operations performed by the reference picture setting unit 140. From among the operations illustrated in FIG. 15, the operations that are substantively identical to the operations illustrated in FIG. 6 are referred to by the same step numbers.

As illustrated in FIG. 15, in the video coding device 2, the reference picture is selected in an identical manner to that in the video decoding device 1 (Step S104 to Step S106).

Then, in the video coding device 2, videos having a plurality of viewpoints (i.e., a coded stream) is generated using the reference picture (Step S121).

In this way, with the video coding device 2, coding of multiview video can be performed using the fourth example of prediction structure illustrated in FIG. 7.

Furthermore, in the video coding method according to the embodiment, if it is determined that the image of interest is an intra predictive image; at least one image from the image of interest and image that is viewed at a different time than the target image and that is coded based on the image of interest is selected as the reference picture of a target image to be coded. As a result, it becomes possible to achieve reduction in delay as well as a high coding efficiency at the same time.

Herein, the video decoding device 1 as well as the video coding device 2 can be implemented with a commonly-used computer device as the basic hardware. Thus, each of the entropy decoding unit 110, the inverse quantization unit 120, the inverse orthogonal transform unit 130, the reference picture setting unit 140, the predictive image generating unit 150, the adding unit 155, the output image selecting unit 170, the subtracting unit 200, the orthogonal transform unit 210, the quantization unit 220, and the entropy coding unit 230 can be implemented by executing computer programs in a processor that is installed in the computer device. Alternatively, in the video decoding device 1 as well as the video coding device 2, at least some of the above-mentioned constituent elements can be configured with hardware circuits instead of using computer programs.

At that time, the video decoding device 1 as well as the video coding device 2 can be implemented by installing in advance the abovementioned computer programs in a computer device; or can be implemented by storing the computer programs in a memory medium such as a compact disk read only memory (CD-ROM) or by distributing the computer programs over a network, and then by downloading the computer programs in the computer device. Meanwhile, the reference picture storing unit 160 can be implemented using a memory medium such as a built-in memory or an external memory of the computer device; a hard disk; a compact disk recordable (CD-R); a compact disk rewritable (CD-RW); a digital versatile disk random access memory (DVD-RAM); or a digital versatile disk recordable (DVD-R).

Herein, the computer device can be configured not to display 2D images. For that, in the computer device, it can be ensured that the images viewed at the time t₀ illustrated in FIG. 7 are not displayed and that only the images viewed at the time t₁ and the subsequent times are displayed.

Meanwhile, the base viewpoint is not limited to a single viewpoint serving as the base view. For example, if viewpoints other than the base view, which include the images I in an identical manner to the base view and which are coded or decoded by performing the same operations as those performed in coding or decoding the base view, are set in such a way that the number of base viewpoints is smaller than the total number of viewpoints; then those viewpoints can be considered to be the base viewpoints. That is because, if viewpoints are set in such a way that the number of base viewpoints is smaller than the total number of viewpoints; then there is a decrease in the number of images I having the viewpoints other than the base viewpoints. Hence, it becomes possible to achieve enhancement in the coding efficiency as well as reduction in the delay.

In the embodiment described above, the explanation is given for an example in which bi-directional predictive pictures and bi-predictive prediction-pictures are not used. However, the embodiment is not the only possible case. Alternatively, it is also possible to use backward reference pictures. However, as compared to a video decoding method and a video coding method in which backward reference pictures are used; a video decoding method and a video coding method in which backward reference pictures are not used enable achieving more reduction in the delay.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A multiview video decoding device to decode a target image to be decoded using a first reference picture, the device comprising:
a determining unit to determine whether or not an image of interest of a base viewpoint is an intra predictive image that has been decoded using intra prediction, the image of interest being included in a coded stream obtained by coding video viewed from a plurality of viewpoints and being earlier in a decoding order than the target image; and
a selecting unit to, when the determining unit determines that the image of interest is the intra predictive image, select, as the first reference picture, at least one image from the image of interest and an image that is viewed at a different time than the target image and that is decoded based on the image of interest.

2. The device according to claim 1, further comprising a reference order setting unit to set a reference order among the plurality of viewpoints, wherein
the selecting unit selects, as the first reference picture, a second reference picture that is previous in the reference order than the target image and that is viewed immediately before the target image from a different viewpoint than the target image.

3. The device according to claim 2, wherein, when the second reference picture is not present, the selecting unit does not perform selection of the first reference picture.

4. The device according to claim 3, wherein, when the second reference picture is not present, the selecting unit regards, as identical to the target image, an image that is previous in the reference order than the target image and that is viewed at the same time as the target image but from a different viewpoint.

5. The device according to claim 3, wherein, when the second reference picture is not present, the selecting unit regards, as identical to the target image, an image that is previous by two or more images in the reference order and that is viewed at the same time as the target image but from a different viewpoint.

6. The device according to claim 2, wherein the reference order setting unit sets the reference order in accordance with viewpoint numbers that are written in the coded stream.

7. The device according to claim 1, wherein, when the image of interest is the first image of multiview video that is decoded in succession, the selecting unit regards, as identical to the image of interest, an image that is viewed at the same time as the image of interest from a viewpoint other than the base viewpoint.

8. The device according to claim 1, wherein, when the image of interest is the first image of multiview video that is decoded in succession, images that are viewed at the same time as the image of interest from viewpoints other than the base viewpoint are synthesized.

9. The device according to claim 1, wherein the image of interest is an image viewed immediately before the target image.

10. The device according to claim 1, further comprising an output image selecting unit to,
when a time at which an image to be output is viewed is same as a decoding start time, select and output a decoded image of the base viewpoint, and
when a time at which an image to be output is viewed is not same as a decoding start time, select and output a decoded image of a decoding target viewpoint.

11. A multiview video coding device to generate a coded stream obtained by coding video viewed from a plurality of viewpoints using a first reference picture, the device comprising:
a determining unit to determine whether or not an image of interest of a base viewpoint is an intra predictive image that has been coded using intra prediction, the image of interest being earlier in a coding order than a target image to be coded in the video of the plurality of viewpoints; and
a selecting unit to, when the determining unit determines that the image of interest is the intra predictive image, select, as the first reference picture, at least one image from the image of interest and an image that is viewed at a different time than the target image and that is coded based on the image of interest.

12. The device according to claim 11, further comprising a reference order setting unit to set a reference order among the plurality of viewpoints, wherein
the selecting unit selects, as the first reference picture, a second reference picture that is previous in the reference order than the target image and that is viewed immediately before the target image from a different viewpoint than the target image.

13. The device according to claim 12, wherein, when the second reference picture is not present, the selecting unit does not perform selection of the first reference picture.

14. The device according to claim 13, wherein, when the second reference picture is not present, the selecting unit regards, as identical to the target image, an image that is previous in the reference order than the target image and that is viewed at the same time as the target image but from a different viewpoint.

15. The device according to claim 13, wherein, when the second reference picture is not present, the selecting unit regards, as identical to the target image, an image that is previous by two or more images in the reference order and that is viewed at the same time as the target image but from a different viewpoint.

16. The device according to claim 12, wherein, when the reference order setting unit sets the reference order in accordance with viewpoints numbers that are written in the coded stream.

17. The device according to claim 11, wherein, when the image of interest is the first image of multiview video that is coded in succession, the selecting unit regards, as identical to the image of interest, an image that is viewed at the same time as the image of interest from a viewpoint other than the base viewpoint.

18. The device according to claim 11, wherein the image of interest is an image viewed immediately before the target image.

19. The device according to claim 11, wherein the base viewpoint points to a base view provided to maintain compatibility with a single coded stream.

20. A multiview video decoding method of decoding a target image to be decoded using a first reference picture, the method comprising:
determining whether or not an image of interest of a base viewpoint is an intra predictive image that has been decoded using intra prediction, the image of interest being included in a coded stream obtained by coding video viewed from a plurality of viewpoints and being earlier in a decoding order than the target image; and
selecting, when the image of interest is determined to be the intra predictive image, as the first reference picture, at least one image from the image of interest and an image that is viewed at a different time than the target image and that is decoded based on the image of interest.
